(19) United States
(12) Patent Application Publication
(10) Pub. No.: US 2019/0272465 A1
(43) Pub. Date: Sep. 5, 2019

(54) REWARD ESTIMATION VIA STATE PREDICTION USING EXPERT DEMONSTRATIONS

(71) Applicant: INTERNATIONAL BUSINESS MACHINES CORPORATION, Armonk, NY (US)

(72) Inventors: Daiki Kimura, Tokyo (JP); Sakyasingha Dasgupta, Tokyo (JP); Subhajit Chaudhury, Kanagawa (JP); Ryuki Tachibana, Kanagawa-ken (JP)

(21) Appl. No.: 15/909,304

(22) Filed: Mar. 1, 2018

(51) Int. Cl. G06N 3/08; G06N 3/04

(52) U.S. Cl. CPC G06N 3/08; G06N 3/0472; G06N 3/0481

(57) ABSTRACT

A computer-implemented method, computer program product, and system are provided for estimating a reward in reinforcement learning. The method includes preparing a state prediction model trained to predict a state for an input using visited states in expert demonstrations performed by an expert. The method further includes inputting an actual state observed by an agent in reinforcement learning into the state prediction model to calculate a predicted state. The method also includes estimating a reward in the reinforcement learning based, at least in part, on similarity between the predicted state and an actual state observed by the agent.

### BACKGROUND

### Technical Field

The present disclosure, generally, relates to machine learning, more particularly, to a method, a computer system and a computer program product for estimating a reward in reinforcement learning.

### Description of the Related Art

Reinforcement learning (RL) deals with learning the desired behavior of an agent to accomplish a given task. Typically, a reward signal is used to guide the agent's behavior and the agent learns an action policy that maximizes the cumulative reward over a trajectory, based on observations.

In the most RL methods, a well-designed reward function is required to successfully learn a good action policy for performing the task. Inverse reinforcement learning (IRL) is one of methods collectively referred to as “imitation learning”. In the IRL, an optimal reward function is tried to be recovered as a best description behind given expert demonstrations obtained from humans or other experts. In the conventional IRL, it is typically assumed that the expert demonstrations contain both the state and action information to solve the imitation learning problem.

However, to acquire such action information, enormous computational resources, which may include resources for obtaining sensor information and analyzing the obtained sensor information, are required. Even though such computational resources are allowed, there are many cases where the action information is not readily available.

### SUMMARY

According to an embodiment of the present invention, a computer-implemented method for estimating a reward in reinforcement learning is provided. The method includes preparing a state prediction model trained to predict a state from an input using visited states in expert demonstrations performed by an expert. The method also includes inputting an actual state observed by an agent in reinforcement learning into the state prediction model to calculate a predicted state. The method further includes estimating a reward in the reinforcement learning based, at least in part, on similarity between the predicted state and an actual state observed by the agent.

Computer systems and computer program products relating to one or more aspects of the present invention are also described and claimed herein.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 illustrates a block diagram of a reinforcement learning system with novel reward estimation functionality according to an exemplary embodiment of the present invention;

FIG. 2A depicts a schematic of an environment of a robotic arm reaching task to a point target according to an exemplary embodiment of the present invention;

FIG. 2B depicts a schematic of an environment of a task of controlling a point agent to reach a target position while avoiding an obstacle according to an exemplary embodiment of the present invention;

FIG. 2C depicts a schematic of an environment of a task of playing a video game according to an exemplary embodiment of the present invention;

FIG. 3 is a flowchart depicting a reinforcement learning process with novel reward estimation according to the exemplary embodiment of the present invention;

FIG. 4A describes a generative model that can be used as the state prediction model according to an exemplary embodiment of the present invention;

FIG. 4B describes a temporal sequence prediction model that can be used as the state prediction model according to an exemplary embodiment of the present invention;

FIG. 5A describes a temporal sequence prediction model that can be used in the inverse reinforcement learning according to an exemplary embodiment of the present invention;

FIG. 5B describes a temporal sequence prediction model that can be used as the state prediction model according to an exemplary embodiment of the present invention;

FIG. 6A shows performance of reinforcement learning for Reacher tasks to a fixed point target, respectively;

FIG. 6B shows performance of reinforcement learning for Reacher tasks to a random point target, respectively;

FIG. 7A shows the reward values for each end-effector position and target position for a dense reward according to an exemplary embodiment of the present invention;

FIG. 7B shows the reward values for each end-effector position and target position for a sparse reward according to an exemplary embodiment of the present invention;

FIG. 7C shows the reward values for each end-effector position and target position for a generative model (GM) reward trained by τ^{1k} according to an exemplary embodiment of the present invention;

FIG. 7D shows the reward values for each end-effector position and target position for a GM reward trained by τ^{2k} according to an exemplary embodiment of the present invention;

FIG. 8A shows performance of reinforcement learning for Mover;

FIG. 8B show performance of reinforcement learning for Flappy Bird™ tasks;

FIG. 9 shows performance of reinforcement learning for Super Mario Bros.™ tasks; and

FIG. 10 depicts a schematic of a computer system according to one or more embodiments of the present invention.

### DETAILED DESCRIPTION

Now, the present invention will be described using particular embodiments, and the embodiments described hereafter are understood to be only referred to as examples and are not intended to limit the scope of the present invention.

One or more embodiments according to the present invention are directed to computer-implemented methods, computer systems and computer program products for estimating a reward in reinforcement learning via a state prediction model that is trained using expert demonstrations performed by an expert, which contain state information.

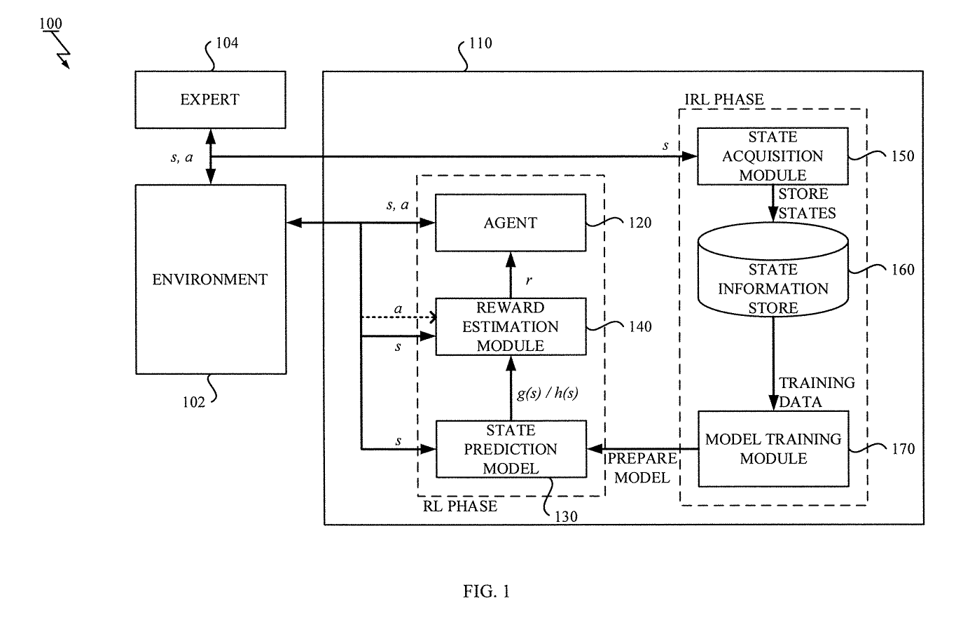

With reference to series of FIGS. 1-5, a computer system and a method for performing reinforcement learning with novel reward estimation according to an exemplary embodiments of the present invention will be described.

FIG. 1 illustrates a block diagram 100 of a reinforcement learning system 110 with novel reward estimation functionality. In the block diagram 100 shown in FIG. 1, there are an environment 102 and an expert 104 in addition to the reinforcement learning system 110.

The environment 102 is an environment where an reinforcement learning agent or the expert 104 interacts. The expert 104 may demonstrate desired behavior in the environment 102 to provide a set of expert demonstrations that the reinforcement learning agent tries to tune its parameters to match. The expert 104 is expected to perform optimal behavior in environment 102. The expert 104 is one or more experts, each of which may be any of a human expert and a machine expert that has been trained in other way or previously trained by the reinforcement learning with novel reward estimation according to the exemplary embodiment of the present invention.

The reinforcement learning system 110 performs reinforcement learning with the novel reward estimation. During a phase of inverse reinforcement learning (IRL), the reinforcement learning system 110 learns a reward function appropriate for the environment 102 by using the expert demonstrations that are actually performed by the expert 104. During runtime of the reinforcement learning (RL), the reinforcement learning system 110 estimates a reward by using the learned reward function, for each action the agent takes, and subsequently learns an action policy for the agent to perform a given task, using the estimated rewards.

As shown in FIG. 1, the reinforcement learning system 110 includes an agent 120 that executes an action and observes a state in the environment 102; a state prediction model 130 that is trained using the expert demonstrations; and a reward estimation module 140 that estimates a reward signal based on a state predicted by the state prediction model 130 and an actual state observed by the agent 120.

The agent 120 is the aforementioned reinforcement learning agent that interacts with the environment 102 in time steps and updates the action policy. At each time, the agent 120 observes a state (s) of the environment 102. The agent 120 selects an action (a) from the set of available actions according to the current action policy and executes the selected action (a). The environment 102 may transit from the current state to a new state in response to the execution of the selected action (a). The agent 120 observes the new state and receives a reward signal (r) from the environment 102, which is associated with the transition. In the reinforcement learning, a well-designed reward function may be required to learn a good action policy for performing the task.

In the exemplary embodiment, the state prediction model 130 and the reward estimation module 140 are used to estimate the reward (r) in the reinforcement learning. The state prediction model 130 and the reward estimation module 140 will be described later in more detail.

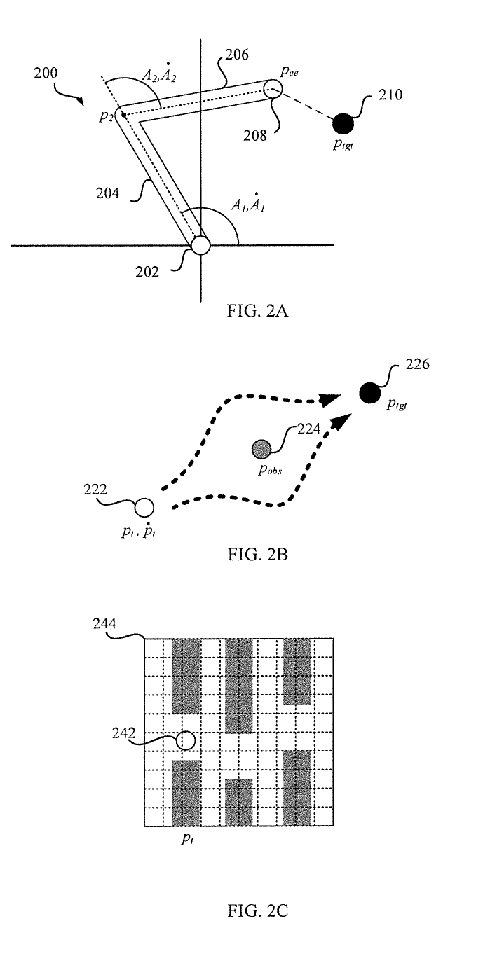

Referring to FIGS. 2A-2C, environments for several tasks according to one or more particular embodiments of the present invention are schematically described.

FIG. 2A illustrates an environment of a robotic arm reaching task to a point target. In the environment shown in FIG. 2A, there is a two degrees of freedom (2-DoF) robotic arm 200 in a 2-dimensional plane (x, y). The robotic arm 200 shown in FIG. 2A has two arms 204, 206 and an end-effector 208. The first arm 204 has one end rigidly linked to the point 202 and is rotatable around the point 202 with a joint angle (A₁). The second arm 206 has one end linked to the first arm 204 and other end equipped with the end-effector 208, and is rotatable around an elbow joint that links the first and second arms 204, 206 with a joint angle (A₂). The first and second arms 204, 206 may have certain lengths (L₁, L₂). The objective is to learn to reach the point target 210 with the end-effector 208 of the robotic arm 200.

In the environment show in FIG. 2A, the state of the environment 102 may include one or more state values selected from a group consisting of the absolute end position of the first arm 204 (p₂), the joint angles of the elbows (A₁, A₂), the velocities of the joints (dA₁/dt, dA₂/dt), the absolute target position (p_{tgt}) and the relative end-effector position from the target (pₑₑ−p_{tgt}). The action may be one or more control parameters such as joint torque used to control the joint angles (A₁, A₂).

Note that FIG. 2A shows a case of the 2-DoF robotic arm in the x-y plane as one example. However, the form of the robotic arm 200 that can be used for the environment 102 is not limited to the specific example shown in FIG. 2A. In other embodiment, a 6-DoF robotic arm in an x-y-z space may also be contemplated.

FIG. 2B illustrates an environment of a task of controlling a point agent 222 to reach a target position 226 while avoiding an obstacle 224. The point agent 222 moves in a 2-dimensional plane (x, y) according to position control. In the environment show in FIG. 2B, the state of the environment 102 may include one or more state values selected from a group consisting of the absolute position of the point agent 222 (pₜ), the current velocity of the point agent 222 (dpₜ/dt), the target absolute position (p_{tgt}), the obstacle absolute position (p_{obs}), and the relative positions of the point target 226 and the obstacle 224 with respect to the point agent 222 (pₜ-p_{tgt}, pₜ−p_{obs}). The action may be one or more control parameters used to control the position of the point agent 222. The objective is to learn so that the point agent 222 reaches the point target 226 while avoiding the obstacle 224.

FIG. 2C illustrates a task of playing a video game. There is a video game screen 244 in which a playable character 242 may be displayed. The state of the environment 102 may include an image frame or consecutive image frames of the video game screen 244, which may have an appropriate size. The state of the environment 102 may further include a state value derived from the image frame or the consecutive image frames of the video game screen 244, or other tool such as a game emulator and a simulator (e.g., a position of the playable character 242, score information). The action may be one or more discrete commands of whether to do some type of actions (e.g. flap wing, jump, left, right) or not.

The objective may depend on the type of the video game or the video game itself. For example, the objective may be to pass through the maximum number of obstacles without collision. For other example, the objective may be to travel as far as possible and achieve as high a score as possible.

Note that the environments shown in FIG. 2A-2C are only examples, and other types of environments may also be contemplated.

Referring back to FIG. 1, the reinforcement learning system 110 shown in FIG. 1 further includes a state acquisition module 150 that acquires state information from the expert 104; a state information store 160 that stores state information acquired by the state acquisition module 150; a model training module 170 that train the state prediction model 130 using the state information stored in the state information store 160.

The state acquisition module 150 is configured to acquire expert demonstrations performed by the expert 104 that contains states (s) visited by the expert 104. The state acquisition module 150 acquires the expert demonstrations while the expert 104 demonstrates the desired behavior in the environment 102, which is expected to be optimal (or near optimal).

For example, the expert 104 controls the robotic arm 200 to reach the point target 210 with the end-effector 208 by setting the control parameters, in the case of the environment shown in FIG. 2A. For example, the expert 104 controls the position of the point agent 222 to reach the target position 226 while avoiding the obstacle 224 by setting the control parameters, in the case of the environment shown in FIG. 2B. For example, the expert 104 controls the playable character 242 by submitting discrete commands to pass through the obstacles without collision as many as possible or to travel as far as possible and achieve as high a score as possible, in the cases of the environment shown in FIG. 2C.

The state information store 160 is configured to store the expert demonstrations acquired by the state acquisition module 150 in an appropriate storage area.

The model training module 170 is configured to prepare the state prediction model 130, which is used to estimate the reward signal (r) in the following reinforcement learning, by using the expert demonstrations stored in the state information store 160. The model training module 170 is configured to read the expert demonstrations as training data and train the state prediction model 130 using states in the expert demonstrations, which are actually visited by the expert 104 during the demonstrations. In a preferable embodiment, the model training module 170 trains the state prediction model 130 without actions executed by the expert 104 in relation to the visited states. Note that the training is performed so as to make the trained state prediction model 130 be a model of “good” state distribution in the expert demonstrations. The way of training the state prediction model 130 will be described later in more detail.

The state prediction model 130 is configured to predict, for an inputted state, a state similar to the expert demonstrations that has been used to train the state prediction model 130. By inputting an actual state observed by the agent 120 into the state prediction model 130, the state prediction model 130 calculates a predicted state for the inputted actual state. If the inputted actual state is similar to some state in the expert demonstrations, which has been actually visited by the expert 104 during the demonstration, the state prediction model 130 predicts a state that is not changed a lot from the inputted actual state. On the other hand, if the inputted actual state is different from any states in the expert demonstrations, the state prediction model 130 predicts a state that is not similar to the inputted actual state.

In a particular embodiment, the state prediction model 130 is a generative model that is trained so as to minimize an error between a visited state in the expert demonstrations and a reconstructed state from the visited state. In the particular embodiment with the generative model, the state prediction model 130 may try to reconstruct a state (g(s)) similar to some visited state in the expert demonstrations from the inputted state (s).

In other particular embodiment, the state prediction model is a temporal sequence prediction model that is trained so as to minimize an error between an visited state in the expert demonstrations and an inferred state from one or more preceding visited states in the expert demonstrations. In the particular embodiment with the temporal sequence prediction model, the state prediction model 130 may try to infer a next state (h(s)) similar to the expert demonstrations from the inputted actual current state (s) and optionally one or more preceding actual states.

The generative model and the temporal sequence prediction model will be described later in more detail.

The reward estimation module 140 is configured to estimate a reward signal (r) in the reinforcement learning based, at least in part, on similarity between the state predicted by the state prediction model 130 (g(s)/h(s)) and an actual state observed by the agent 120 (s). The reward signal (r) may be estimated as a higher value as the similarity becomes high. If an actual state observed by the agent 120 is similar to the state predicted by the state prediction model 130, the estimated reward value becomes higher. On the other hand, if an actual state observed by the agent 120 is different from the state predicted by the state prediction model 130, the estimated reward value becomes lower.

In the particular embodiment with the generative model, if the actual state (s) observed by the agent 120 is similar to the reconstructed state (g(s)), the reward is estimated to be high. If the actual state (s) is deviated from the reconstructed state (g(s)), the reward value is estimated to be low. Note that the actual state for the similarity and the actual state inputted into the generative model may be observed at the same time step. In other particular embodiment with the temporal sequence prediction model, the estimated reward can also be interpreted akin to the case of the generative model. Note that the actual state inputted into the temporal sequence prediction model may precede the actual state defining the similarity.

The reward may be defined as a function of similarity measure in both cases of the generative model (g(s)) and the temporal sequence prediction model (h(s)). In particular embodiments, the similarity measure can be defined as the distance (or the difference) between the predicted state and the actually observed state, ∥s−g(s)∥ or ∥s−h(s)∥. This similarity measure becomes smaller as the predicted state and the actually observed state become similar. The function may have any kind of forms, including a hyperbolic tangent function, a Gaussian function or a sigmoid function, as far as the function gives a higher value as the similarity becomes high (the similarity measure becomes small). A function that is monotonically increasing within domain of definition (>0) may be employed. A function that has an upper limit in the range of the function may be preferable.

In preferable embodiments, the reward estimation module 140 estimates the reward signal based further on a cost for a current action that is selected and executed by the agent 120 in addition to the similarity measure, as indicated by the dashed arrow extended to the reward estimation module 140 in FIG. 1. The reward component that accounts for the cost of the action is referred to as an environment specific reward (r^{env}), which works as regularization for finding efficient behavior (e.g. finding shortest path to reach the target target). Furthermore, if there is a trivial suboptimal solution where the agent 120 falls into, the reward estimation module 140 preferably applies a threshold value that prevents the agent 120 from converging onto a suboptimal solution to estimate the reward signal (r).

After receiving the reward signal (r), which is estimated by the reward estimation module 140 with the state prediction model 130 based on an actual state observed by the agent 120 and optionally the action executed by the agent 120, the agent 120 may update parameters of an reinforcement learning network using at least the estimated reward signal (r). The parameters of the reinforcement learning network may include the action policy for the agent 120. The reinforcement learning network may be, but not limited to, a value-based model (e.g., Sarsa, Q-learning, Deep Q Network (DQN)), a policy-based model (e.g. guided policy search), or an actor critic based model (e.g., Deep Deterministic Policy Gradient (DDG), Asynchronous Advantage Actor-Critic (A₃C)).

In a particular embodiment with the DDPG, the reinforcement learning network includes an actor network that has one or more fully-connected layers; and a critic network that has one or more fully-connected layers. The parameters of the reinforcement learning network may include weights of the actor network and the critic network. In a particular embodiment employing the DQN, the reinforcement learning network includes one or more convolutional layers, each of which has certain kernel size, the number of the filters and the number of the strides; one fully connected layer; and a final layer.

In particular embodiments, each of the modules 120, 130, 140, 150, 160 and 170 in the reinforcement learning system 110 described in FIG. 1 may be implemented as a software module including program instructions and/or data structures in conjunction with hardware components such as a processing circuitry (e.g., a Central Processing Unit (CPU), a processing core, a Graphic Processing Unit (GPU), a Field Programmable Gate Array (FPGA)), a memory, etc.; as a hardware module including electronic circuitry (e.g., a neuromorphic chip); or as a combination thereof.

These modules 120, 130, 140, 150, 160 and 170 described in FIG. 1 may be implemented on a single computer system such as a personal computer and a server machine or a computer system distributed over a plurality of computing devices such as a computer cluster of computing nodes, a client-server system, a cloud computing system and an edge computing system.

In a particular embodiment, the modules used for the IRL phase (130, 150, 160, 170) and the modules used for the RL phase (120, 130, 140) may be implemented on respective computer systems separately. For example, the modules 130, 150, 160, 170 for the IRL phase are implemented on a vender-side computer system and the modules 120, 130, 140 for the RL phase are implemented on a user-side (edge) device. In this configuration, the trained state prediction model 130 and optionally parameters of the reinforcement learning network, which has been trained partially, are transferred from the vender-side system to the user-side device, and the reinforcement learning continues on the user-side device.

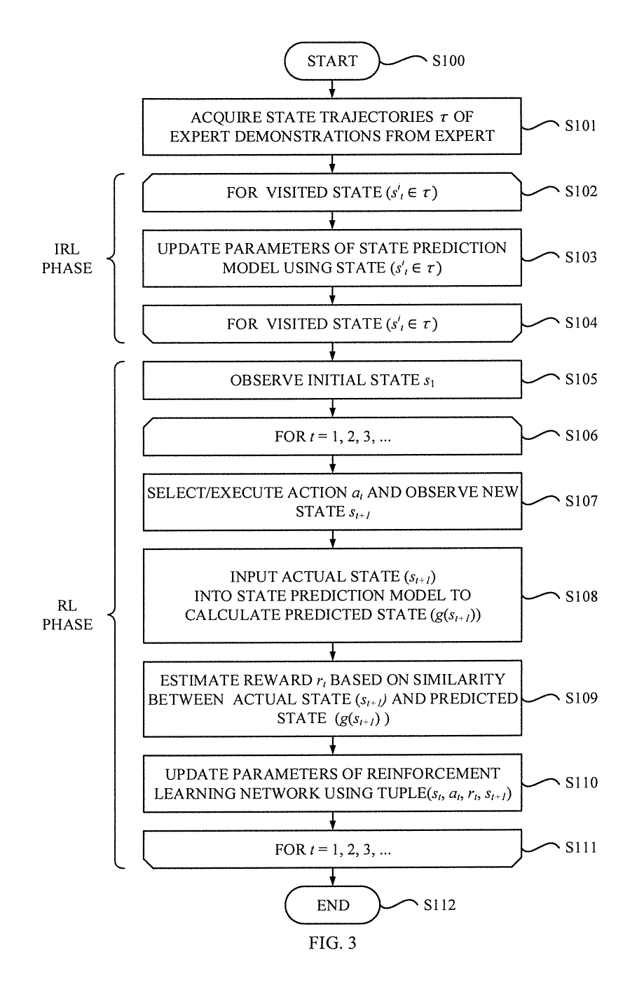

With reference to FIG. 3, a reinforcement learning process with novel reward estimation for training an agent to perform a given task is depicted. As shown in FIG. 3, the process may begin at step S100 in response to receiving, from an operator, a request for initiating the reinforcement learning process. Note that the process shown in FIG. 3 may be performed by processing circuitry such as a processing unit.

At step S101, the processing circuitry may acquire state trajectories of expert demonstrations from the expert 104 that performs demonstrations in the environment 102. The environment 102 is typically defined as an incomplete Markov decision process (MDP), including state S and action A spaces, where a reward signal r: SxA-+R, is unknown. The expert demonstrations may include a finite set of optimal or expert state trajectories τ={S⁰, S¹, . . . , S^{M}}, where, Sⁱ={sⁱ₀, sⁱ₁, . . . , sⁱ_{N}}, with i∈{1, 2, . . . , M}. Let, τ={sⁱₜ}_{i=1:M, t=1:N} be the optimal states visited by the expert 104 in the expert demonstrations, where M is the number of episodes in the expert demonstrations, and N is the number of steps within each episode. Note that the number of steps in one episode may be same as or different from other episode. The state vector sⁱₜ may represent positions, joints angles, raw image frames and/or any other information depicting the state of the environment 102 in a manner depending on the environment 102, as described above.

The loop from step S102 to step S104 represents the IRL phase, in which, at step S103, the processing circuitry may train the reward function (i.e., the state prediction model 130) by using the state trajectories τ of the expert demonstrations.

Since the reward signal r of the environment 102 is unknown, the objective of the IRL is to find an appropriate reward function that can maximize the likelihood of the finite set of the state trajectories τ, which in turn is used to guide the following reinforcement learning and enable the agent 120 to learn a suitable action policy π (aₜ|sₜ). More specifically, in the IRL phase, the processing circuitry may try to find a reward function that maximizes the following objective:

$${r}^{*} = {arg max}_{r} {E}_{p ( {S}_{t + 1} \vert {S}_{t} )} r ( {s}_{t + 1} \vert {s}_{t} ) , \qquad ( 1 )$$

where r(sₜ₊₁|sₜ) is the reward function of the next state given the current state and p(sₜ₊₁|sₜ) is the transition probability. It is considered that the optimal reward is estimated based on the transition probabilities predicted using the state trajectories τ of the expert demonstrations.

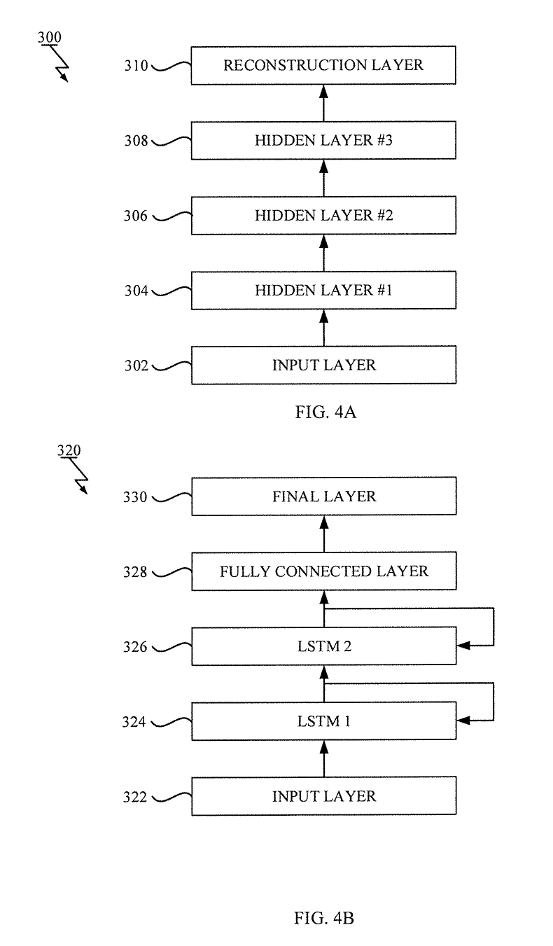

As described above, the state prediction model 130 may be a generative model or a temporal sequence prediction model. Hereinafter, first, referring to FIG. 3 with FIG. 4A, the flow of the process employing the generative model is described.

FIG. 4A illustrates a schematic of an example of generative model that can be used as the state prediction model 130. The example of the generative model shown in FIG. 4A is an autoencoder 300. The autoencoder 300 is a neural network that has an input layer 302, one or more (three in the case shown in FIG. 4A) hidden layers 304, 306, 308 and a reconstruction layer 310. The middle hidden layer 306 may be called a a code layer, the first half part before the middle hidden layer 306 constitutes an encoder and the latter half part after the middle hidden layer 306 constitutes a decoder. The input may pass through the encoder to generate a code. The decoder then produces the output using the code. During the training, the autoencoder 300 trained so as to generate an output identical with the input. The dimensionality of the input and the output is typically the same. Note that the structure of the encoder part and the structure of the decoder part may be or may not be mirror image each other. Also, the number of the hidden layers is not limited to three, one layer or more than three layers may also be contemplated.

In the RL phase represented by the steps 102-104, the generative model such as the autoencoder 300 shown in FIG. 4A is trained using the state values sⁱₜ for each step t, sampled from the expert state trajectories r. The generative model is trained to minimize the following reconstruction loss (maximize the likelihood of the training data):

$${θ}_{g}^{*} = {arg min}_{{θ}_{g}} [ - {\sum }_{i = 1}^{M} {\sum }_{t = 1}^{N} log p ( {s}_{t}^{i} ; {θ}_{g} ) ] , \qquad ( 2 )$$

where θ*_{g} represents the optimum parameters of the generative model. In a typical setting, p(sⁱₜ; θ_{g}) can be assumed to be a Gaussian distribution, such that the equation (2) leads to minimizing the mean square error between the actual state sⁱₜ and the generated state g(sⁱₜ; θ_{g}), as follows:

$${‖ {s}_{t}^{i} - g ( {s}_{t}^{i} ; {θ}_{g} ) ‖}_{2} .$$

The process from step S105 to step S111 represents the RL phase, in which the processing circuitry may iteratively learn the action policy for the agent 120 using the learned reward function (i.e., the state prediction model 130).

At step S105, the processing circuitry may observe an initial actual state sl by the agent 120. The loop from step S106 to step S111 may be repeatedly performed for every time steps t (=1, 2, . . . ) until a given termination condition is satisfied (e.g., max number of steps, convergence determination condition, etc.).

At step S107, the processing circuitry may select and execute an action aₜ and observe a new actual state sₜ₊₁ by the agent 120. The agent 120 can select the action aₜ according to the current policy. The environment 102 may transit from the current actual state sₜ to the next actual state sₜ₊₁ in response to the execution of the current action aₜ.

At step S108, the processing circuitry may input the observed new actual state sₜ₊₁ into the state prediction model 130 to calculate a predicted state, g(sₜ₊₁; θ_{g}).

At step S109, the processing circuitry estimates a reward signal rₜ by the reward estimation module 140 based on the actual new state sₜ₊₁ and the predicted state g(sₜ₊₁;θ_{g}) from the actual new state sₜ₊₁. The reward signal rₜ may be estimated as a function of the difference between the observed state and the predicted state, as follows:

$${r}_{t}^{g} = ψ ( - {‖ {s}_{t + 1} - g ( {s}_{t - 1} ; {θ}_{g} ) ‖}_{2} ) , \qquad ( 3 )$$

where sₜ₊₁ is the observed actual state value, and ψ can be a linear or nonlinear function, typically hyperbolic tangent (tanh) or Gaussian function. If the actual state sₜ₊₁ is similar to the reconstructed state, g(sₜ₊₁; θ_{g}), the estimated reward value becomes higher. If the actual state sₜ₊₁ is not similar to the reconstructed state g(sₜ₊₁; θ_{g}), the reward value becomes lower.

At step S110, the processing circuitry may update the parameters of the reinforcement learning network using at least the currently estimated reward signal rₜ, more specifically, a tuple (sₜ, aₜ, rₜ, sₜ₊₁).

After exiting the loop from step S106 to step S111 for every time step t (=1, 2, . . . ), the process may proceed to step S112 to end the process.

Note that the process shown in FIG. 3 has been described such that the loop from the step S106 to the step S111 is performed for every time steps t=1, 2, . . . , which may constitutes one episode, for the purpose of illustration. However, there may be one or more episodes for the RL phase and the process from the step S105 to the step S111 may be repeatedly performed for each episode.

Employing the generative model that is trained using the expert state trajectories τ is a kind of straightforward approach. The rewards can then be estimated based on the similarity measures between the reconstructed state and the actual state. The method may constrain exploration to the states that have been demonstrated by the expert 104 and enables learning the action policy that closely matches the expert 104.

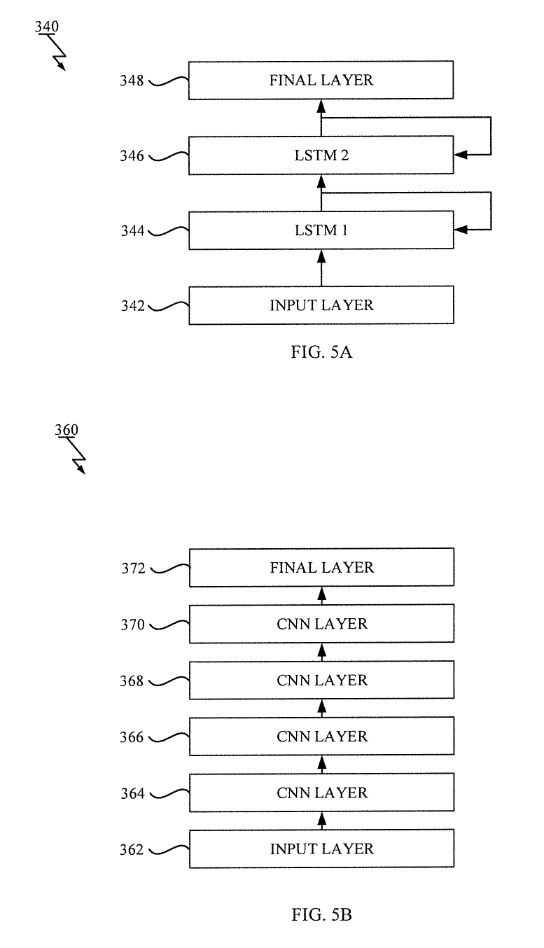

Meanwhile, the temporal order of the states is beneficial information for estimating the state transition probability function. Hereinafter, referring to FIG. 3, FIGS. 4A and 4B and FIG. 5A and FIG. 5B, second approach that can account for the temporal order of the states by employing a temporal sequence prediction model as the state prediction model 130 will be described as alternative embodiments. The temporal sequence prediction model can be trained to predict the next state given current state based on the expert state trajectories τ. The reward signal can be estimated as a function of the similarity measure between the predicted next state and one actually observed by the agent as similar to the embodiment with the generative model.

In the alternative embodiment, in the RL phase represented by the steps 102-104 in FIG. 3, the temporal sequence prediction model is trained such that the likelihood of the next state given the current state is maximized. More specifically, the temporal sequence prediction can be trained using the following objective function:

$${θ}_{h}^{*} = {arg min}_{{θ}_{h}} [ - {\sum }_{i = 1}^{M} {\sum }_{t = 1}^{N} log p ( {s}_{t + 1}^{i} \vert {s}_{t}^{i} ; {θ}_{g} ) ] , \qquad ( 4 )$$

where θ*ₕ represents the optimal parameters of the temporal sequence prediction model. The probability of the next state given the previous state value, p(sⁱₜ₊₁|sⁱₜ;θₕ) is assumed to be a Gaussian distribution. The objective function can be seen to be minimizing the mean square error between the actual next state sⁱₜ₊₁, and the predicted next state h(sⁱₜ; θₕ), which is represented as follows:

$${‖ {s}_{t + 1}^{i} - h ( {s}_{t}^{i} ; {θ}_{h} ) ‖}_{2} .$$

At the step S109, the processing circuitry may estimate a reward signal rₜ as a function of the difference between the actual next state sₜ₊₁ and the predicted next state, as follows:

$${r}_{t}^{h} = ψ ( - {‖ {s}_{t + 1} - h ( {s}_{t} ; {θ}_{h} ) ‖}_{2} ) , \qquad ( 5 )$$

where sₜ₊₁ is the actual next state value, and ψ can be a linear or nonlinear function. If the agent's policy takes an action that changes the environment towards states far away from the expert state trajectories τ, the reward is estimated to be low. If the action of the agent 120 brings it close to the expert state trajectories τ, thereby making the predicted next state match with the actual state, the reward is estimated to be high.

Further referring to FIGS. 4A and 4B and FIGS. 5A and 5B, examples of the temporal sequence prediction models that can be used in the IRL according to one or more embodiments of the present invention are schematically described.

The architecture shown in FIG. 4A can also be used as the temporal sequence prediction model, which is called herein as a next state (NS) model. The next state model infers a next state as the predicted state from the actual current state. In the particular embodiment with the next state model, the actual state inputted into the next state model is an actual current state sₜ and the actual state compared with the output of the next state model h(sₜ; θₕ) to define the similarity measure is an actual next state sₜ₊₁. The reward signal rₜ based on the next state model can be estimated as follows:

$$NS reward \text{:} {r}_{t}^{h} = ψ ( - {‖ {s}_{t + 1} - h ( {s}_{t} ; {θ}_{h} ) ‖}_{2} ) .$$

FIG. 4B illustrates a schematic of other example of the temporal sequence prediction model that can be used as the state prediction model 130. The example of the temporal sequence prediction model shown in FIG. 4B is a long short term memory (LSTM) based model 320. The LSTM based model 320 shown in FIG. 4B may have an input layer 322, one or more (two in the case shown in FIG. 4B) LSTM layers 324, 326 with certain activation function, one fully-connected layer 328 with certain activation units and a fully connected final layer 330 with same dimension to the input layer 322.

The LSTM based model 320 infers a next state as the predicted state from the actual state history or the actual current state. In the particular embodiments with the LSTM based model 320, the actual state inputted into the LSTM based model 320 may be an actual state history or an actual current state s_{t-n:t} and the actual state compared with the output of the LSTM based model 320 h(s_{t-n:t}; θₗₛₜₘ) may be an actual next state sₜ₊₁. The reward signal rₜ based on the LSTM based model 320 can be estimated as follows:

$$LSTM reward \text{:} {r}_{t}^{h} = ψ ( - {‖ {s}_{t + 1} - h ( {s}_{t - n : t} ; {θ}_{lstm} ) ‖}_{2} ) ,$$

where s_{t-n:t} represents the actual state history (n>0) or the actual current state (n=0).

Note that the state information involved in the calculation of the reward is not limited to include all state values inputted to the temporal sequence prediction model. In other embodiment, the state information involved in the reward estimation may include a selected part of the state values. Such variant reward signal rₜ based on the LSTM based model 320 can be represented as follows:

LSTM reward(selected state):rₜ^{h}=ψ(−∥s′ₜ₊₁−h′(s_{t-n:t};θₗₛₜₘ)∥₂),

where s′ₜ₊₁ denotes a selected part of the state values corresponding to the inputted actual state history or the actual current state s_{t-n:t}, and h′(s_{t-n:t:}:θₗₛₜₘ) represents a next state inferred by the LSTM based model 320 as a selected part of the state values given the actual state history or the actual current state s_{t-n:t}.

In further other embodiment, the state information involved in the reward estimation may include a derived state that is different from any of the state values s_{t-n:t} inputted into the temporal sequence prediction model. Such variant reward signal rₜ based on the LSTM based model 320 can be represented as follows:

LSTM reward(derived state):rₜ^{h}=ψ(−∥s″ₜ₊₁−h″(s_{t-n:t};θₗₛₜₘ)∥₂),

where s″ₜ₊₁ denotes a state derived from the state value s_{t-n:t} by using a game emulator or simulator, and h″(s_{t-n:t:}:θₗₛₜₘ) represents a next state inferred by the LSTM based model, which corresponds to the state derived.

FIG. 5A illustrates a schematic of further other example of the temporal sequence prediction model. The example of the temporal sequence prediction model shown in FIG. 5A is also a LSTM based model 340. The LSTM based model 340 shown in FIG. 5A has an input layer 342, one or more LSTM layers (two in the case shown in FIG. 5A) 344, 346 and one fully connected final layer 348. The LSTM layers 344, 346 also have certain activation function. The LSTM based model 340 also infers a next state sₜ₊₁ from the actual state history or the actual current state s_{t-n:t}.

Note that the number of the LSTM layers is not limited to two, one or more than two LSTM layers may also be contemplated. Furthermore, any of LSTM layers may be a convolutional LSTM layer where connections of the LSTM layer are convolution instead of the full connection for the ordinal LSTM layer.

FIG. 5B illustrates a schematic of another example of the temporal sequence prediction model that can be used as the state prediction model 130. The example of the temporal sequence prediction model shown in FIG. 5B is a 3-dimensional convolutional neural network (3D-CNN) based model. The 3D-CNN based model 360 shown in FIG. 5B has an input layer 362, one or more (four in the case shown in FIG. 5B) convolutional layers 364, 366, 368, and 370 and a final layer 372 to reconstruct a state.

The 3D-CNN based model 360 infers a next state from the actual state history or the actual current state. In the particular embodiments with 3D-CNN based model 360, the actual state inputted into 3D-CNN based model 360 may be an actual state history or an actual current state s_{t-n:t}, and the actual state compared with the output of the 3D-CNN based model 360 h(s_{t-n:t}; θ_{3dcnn}) may be an actual next state sₜ₊₁. The reward signal rₜ based on the 3D-CNN based model 360 can be estimated as follows:

3D CNN reward:rₜ^{h}=ψ(−∥sₜ₊₁−h(s_{t-n:t};θ_{3dcnn})∥₂).

By referring to FIGS. 4A and 4B and FIGS. 5A and 5B, the several examples of the architecture of the state prediction model 130 has been described. However, architectures of the state prediction model 130 are not limited to the specific examples shown in FIGS. 4A and 4B and FIGS. 5A and 5B. In one or more embodiments, the state prediction model 130 may have any kind of architectures as far as the model can predict, for an inputted state, a state that has some similarity to expert demonstrations that has been used to train the state prediction model 130.

As described above, according to one or more embodiments of the present invention, computer-implemented methods, computer systems and computer program products for estimating a reward in reinforcement learning via a state prediction model that is trained using expert demonstrations containing state information can be provided.

A reward function can be learned using the expert demonstrations through the IRL phase and the learned reward function can be used in the following RL phase to learn a suitable policy for the agent to perform a given task. In some embodiment, merely visual observations of performing the task such as raw video input can be used as the state information of the expert demonstrations. There are many cases among real world environments where action information is not readily available. For example, a human teacher cannot tell the student what amount of force to put on each of the fingers when writing a letter. Preferably, the training of the reward function can be achieved without actions executed by the expert in relation to the visited states, which can be said to be in line with such scenario.

In particular embodiments, no extra computational resources to acquire action information are required. It is suitable even for cases where the action information is not readily available.

Note that in the aforementioned embodiments, the expert 104 is described to demonstrate optimal behavior and the reward is described to be estimated as a higher value as the similarity to the expert's optimal behavior becomes higher. However, in other embodiments, other type of experts that is expected to demonstrate bad behavior to provide a set of negative demonstrations that the reinforcement learning agent tries to tune its parameters to not match is also contemplated, in place of or in addition to the expert 104 that demonstrates optimal behavior. In this alternative embodiment, the state prediction model 130 or a second state predication model is trained so as to predict a state similar to negative demonstrations and the reward is estimated as a higher value as the similarity to the negative demonstration becomes lower.

### EXPERIMENTAL STUDY

A program implementing the reinforcement learning system 110 and the reinforcement learning process shown in FIG. 1 and FIG. 3 according to the exemplary embodiment was coded and executed.

To evaluate the novel reward estimation functionality, five different tasks were considered, including a robot arm reaching task (hereinafter, referred to as the “Reacher” task) to a fixed target position; another Reacher task to a random target position; a task of controlling a point agent to reach a target while avoiding an obstacle (hereinafter, referred to as the “Mover” task); a task of learning an agent for longest duration of flight in the Flappy Bird™ video game; and a task of learning an agent for maximizing the traveling distance in Super Mario Bros.™ video game. The primary differences between the five experimental settings are summarized as follow:

| Environment | Input | Action | RL method |
|---|---|---|---|
| Reacher (fixed point) | Joint angles & | Continuous | DDPG |
| | distance to target | | |
| Reacher (random | Joint angles | Continuous | DDPG |
| point) | | | |
| Mover | Position & distance | Continuous | DDPG |
| | to target | | |
| Flappy Bird ™ | Image & bird | Discrete | DQN |
| | position | | |
| Super Mario Bros. ™ | Image | Discrete | A3C |

Reacher to fixed point target

The environment shown in FIG. 2A where the 2-DoF robotic arm 200 can move in the 2-dimensional plane (x, y) was built on a computer system. The robotic arm 200 has two joint values, A=(A₁, A₂), A₁∈(−∞, +∞), A₂∈[−π, +π]. The point 202 to which the first arm 204 is rigidly linked is the origin (0, 0). The lengths of the first and second arms L₁, L₂ are 0.1 and 0.11 units, respectively. The robotic arm 200 was initialized by random values of the joint angles A₁, A₂ at the initial step for each episode. The applied continuous action values aₜ was used to control the joint angles such that, dA/dt=Aₜ−Aₜ₋₁=0.05aₜ. Each action value was clipped in the range [−1, 1]. The Reacher task was performed using the physics engine within the Roboschool environment.

The point target p_{tgt} was always fixed at (0.1, 0.1). The state vector sₜ includes the following values: the absolute end position of the first arm 204 (p₂), the joint value of the elbow (A₂), the velocities of the joints (dA₁/dt, dA₂/dt), the absolute target position (p_{tgt}), and the relative end-effector position from target (pₑₑ−p_{gt}). DDPG was employed as the RL algorithm, with the number of steps for each episode being 500 in this experiment.

The DDPG's actor network has 400 and 300 unites fully-connected layers, the critic network has also 400 and 300 fully-connected layers, and each layer has a Rectified Linear Unit (ReLU) activation function. The tanh activation function is put at the final layer of the actor network. The initial weights were set from uniform distribution U (−0.003, +0.003). The exploration policy is Ornstein-Uhlenbeck process (0=0.15, p=0, G=0.01), size of reply memory was set to be 1M, and Adam was used as an optimizer. The experiment was implemented by Keras-rl, Keras, and Tensorflow™ libraries.

The reward functions used in the Reacher task to the fixed point target were as follows:

$$\begin{matrix} Dense reward \text{:} {r}_{t} = - {‖ {p}_{ee} - {p}_{tgt} ‖}_{2} + {r}_{t}^{env} , & ( 6 ) \\ Sparse reward \text{:} {r}_{t} = - tanh ( α {‖ {p}_{ee} - {p}_{tgt} ‖}_{2} ) + {r}_{t}^{env} , & ( 7 ) \\ GM reward ( 2 k ) without {r}_{t}^{env} \text{:} {r}_{t} = - tanh ( β {‖ {s}_{t + 1} - g ( {s}_{t + 1} ; {θ}_{2 K} ) ‖}_{2} ) , & ( 8 ) \\ GM reward ( 2 k ) with {r}_{t}^{env} \text{:} {r}_{t} = - tanh ( β {‖ {s}_{t + 1} - g ( {s}_{t + 1} ; {θ}_{2 K} ) ‖}_{2} ) + {r}_{t}^{env} , & ( 9 ) \\ GM reward ( 1 k ) with {r}_{t}^{env} \text{:} {r}_{t} = - tanh ( β {‖ {s}_{t + 1} - g ( {s}_{t + 1} ; {θ}_{1 K} ) ‖}_{2} ) + {r}_{t}^{env} , & ( 10 ) \\ GM reward with {a}_{t} \text{:} {r}_{t} = - tanh ( β {‖ [ {s}_{t + 1} , {a}_{t} ] - g ( [ {s}_{t + 1} , {a}_{t} ] ; {θ}_{2 K , + a} ) ‖}_{2} ) + {r}_{t}^{env} , & ( 11 )\end{matrix}$$

where rₜ^{env} is an environment specific reward, which can be calculated based on the cost for the current action, −∥aₜ∥₂. This regularization helps the agent 120 find the shortest path to reach the target.

The dense reward is a distance between the end-effector 208 and the point target 210. The sparse reward is based on a bonus for reaching. The dense reward function (6) and the sparse reward function (7) were employed as comparative examples (Experiments 1, 2).

The parameters θ₂ₖ of the generative model for the GM reward (2k) without and with rₜ^{env} (8), (9) was trained by using a set of expert state trajectories τ^{2k} that contain only states of 2000 episodes from a software expert that was trained during 1000 episodes with the dense reward. The generative model has three fully-connected layers with 400, 300 and 400 units, respectively. The ReLU activation function was used, the batch size was 16 and the number of epochs was 50. The parameters θ₁ₖ of the generative model for the GM reward (1k) function with rₜ^{env} (10) was trained from a subset of expert state trajectories τ^{1k} that is randomly picked 1000 episodes from the set of the expert state trajectories τ^{2k}. The GM reward (2k) function without rₜ^{env} (8), the GM reward (2k) function with rₜ^{env} (9) and GM reward (1k) function with rₜ^{env} (10) were employed as Examples (Experiments 3, 4, 5).

The parameters θ_{2k, +a} of the generative model for the GM reward with the action aₜ (11) was trained using pairs of a state and an action for 2000 episodes for same expert demonstration as the set of the expert state trajectories τ^{2k}. The GM reward function with the action aₜ was also employed as an Example (Experiment 6).

The parameters α, β, which may change sensitiveness of the distance or the reward, are both 100. The conventional behavior cloning (BC) method where the trained actor networks directly use obtained pairs of states and actions was also performed as a comparative example (Experiment 7; baseline).

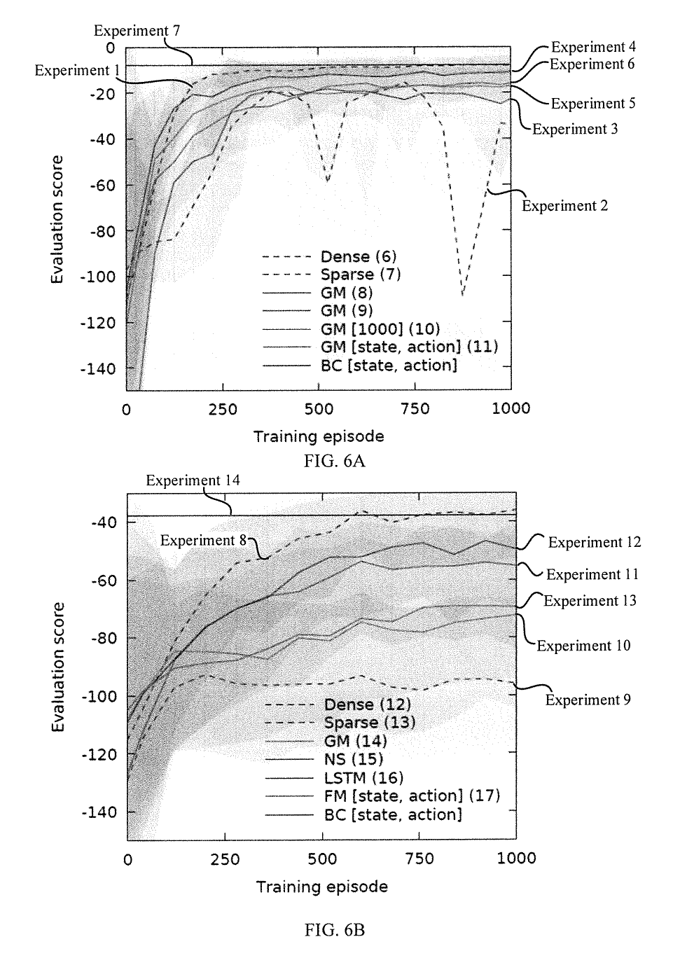

FIG. 6A shows difference in performance of the reinforcement learning of the various reward functions in the Reacher task to the fixed point target. Note that the line in the graph represents average and the gray scale area represents an extent of distribution. The dense reward function was used to calculate the score for all reward functions. As shown in FIG. 6A, the performance of the GM reward (2k/1 k) function without or with rₜ^{env} (Experiments 3, 4, 5) was much better as compared to the sparse reward (Experiment 2). Furthermore, the GM reward function (2k) with rₜ^{env} (Experiment 4) achieved a score nearing that of the dense reward (Experiment 1). Note that the performance of the dense reward (Experiment 1) was considered as reference.

Furthermore, the learning curves based on the rewards estimated by the generative model (Experiments 3, 4, 5) showed a faster convergence rate. As shown in FIG. 6A, the GM reward function (2k) with rₜ^{env} (Experiment 4) took shorter time to converge than the GM reward function (2k) without rₜ^{env} (Experiment 3). The GM reward (2k) function (Experiment 4) outperformed the GM reward (1k) function (Experiment 5) because of the abundance of demonstration data.

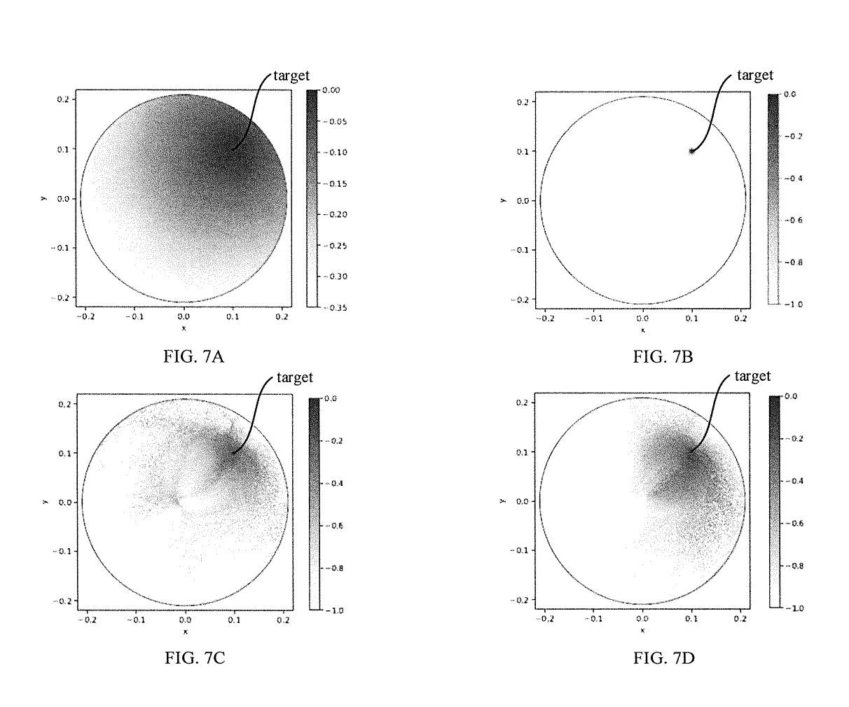

FIGS. 7A-7D show the reward values for each end-effector position. The reward values in the map shown in FIGS. 7A-7D were averaged over 1000 different states values for the same end-effector position. FIG. 7A shows a reward map for the dense reward. FIG. 7B shows a reward map for the sparse reward. FIGS. 7C and 7D show reward maps for the GM reward (1k) function and the GM reward (2k) function, respectively. The GM (2k) reward showed a better reward map as compared to the GM (1k) reward.

The behavior cloning (BC) method that utilize the action information in addition to state information achieved good performance (Experiment 7). However, when using merely state information (excluding the action information) to train the generative model (Experiment 4), the performance of the agent was comparatively good as compared to the generative model trained using both state and action information (Experiment 6).

In relation to the function form of the reward function, other values of parameter β, which included 10, 100 in addition to 10, were also evaluated. Among these evaluations, the tanh function with β=100 showed best performance. In relation to the function form of the reward function, other types of the function were also evaluated in addition to the hyperbolic tangent. Evaluated functions are represented as follows:

$$GM reward ( raw ) \text{:} {r}_{t} = - {‖ {s}_{t + 1} - g ( {s}_{t + 1} ; θ ) ‖}_{2} + {r}_{t}^{env} , \\ GM reward ( div ) \text{:} {r}_{t} = - \frac{{‖ {s}_{t + 1} - g ( {s}_{t + 1} ; θ ) ‖}_{2}}{{d}_{max}} + {r}_{t}^{env} , \\ where {d}_{max} = {max}_{i ∈ \{ 1 , … , , t - 1 \}} {‖ {s}_{i} - g ( {s}_{i} ; θ ) ‖}_{2}$$

$$GM reward ( sigmoid ) \text{:} {r}_{t} = - σ ( 100 {‖ {s}_{t + 1} - g ( {s}_{t + 1} ; {θ}_{2 K} ) ‖}_{2} ) + {r}_{t}^{env} , \\ where σ = \frac{1}{1 + {e}^{- x}} .$$

Among these different functions, the sigmoid function showed comparable performance with the hyperbolic tangent function.

Reacher to Random Point Target

The environment shown in FIG. 2A was also used for the Reacher task to the random point target as same as the experiment of the Reacher task to the fixed point target. The point target p_{tgt} was initialized by a random uniform distribution of [−0.27, +0.27], that includes points outside of the reaching range of the robotic arm 200. The state vector sₜ includes the following values: the absolute end position of the first arm 204 (p₂), the joint value of the elbow (A₂), the velocities of the joints (dA₁/dt, dA₂/dt), and the absolute target position (p_{tgt}). Since the target position p_{tgt} was changed randomly, the temporal sequence prediction models h(sₜ;θₕ) were employed in addition to the generative model. The RL setting was same as the experiment of the Reacher task to the fixed point target; however, the total number of steps within each episode was changed to 400. The reward functions used in the Reacher task to random point target were as follows:

$$\begin{matrix}Dense reward \text{:} {r}_{t} = - {‖ {p}_{ee} - {p}_{tgt} ‖}_{2} + {r}_{t}^{env} , & ( 12 ) \\ Sparse reward \text{:} {r}_{t} = - tanh ( α {‖ {p}_{ee} - {p}_{tgt} ‖}_{2} ) + {r}_{t}^{env} , & ( 13 ) \\ GM reward \text{:} {r}_{t} = tanh ( - β {‖ {s}_{t + 1} - g ( {s}_{t + 1} ; {θ}_{g} ) ‖}_{2} ) + {r}_{t}^{env} , & ( 14 ) \\ NS rewar d \text{:} {r}_{t} = tanh ( - γ {‖ {s}_{t + 1} - h ( {s}_{t} ; {θ}_{h} ) ‖}_{2} ) + {r}_{t}^{env} , & ( 15 ) \\ LSTM reward \text{:} {r}_{t} = tanh ( - γ {‖ {s}_{t + 1} - h ( {s}_{t - n : t} ; {θ}_{lstm} ) ‖}_{2} ) + {r}_{t}^{env} , & ( 16 ) \\ FM model \text{:} {r}_{t} = tanh ( - γ {‖ {s}_{t + 1} - f ( {s}_{t} , {a}_{t} ; {θ}_{+ a} ) ‖}_{2} ) + {r}_{t}^{env} , & ( 17 )\end{matrix}$$

The dense reward is a distance between the end-effector 208 and the point target 210, and the sparse reward is based on a bonus for reaching, as same as the Reacher task to the fixed point target. The dense reward function (12) and the sparse reward function (13) were employed as comparative examples (Experiments 8, 9).

The expert demonstrations τ were obtained using the states of 2000 episodes running an software agent trained by using a dense hand-engineered reward. The GM reward function used in this experiment was same as the Reacher task to the fixed point target. The next state (NS) model that predicts a next state given a current state was trained using same demonstration data τ. The configuration of the hidden layers in the NS model was same as that of the GM model. The finite state history s_{t-n:t} was used as input for the LSTM based model. The LSTM based model has two LSTM layers, one fully-connected layer with 40 ReLU activation units and a fully-connected final layer with the same dimension to the input, as shown in FIG. 4B. Each of the two LSTM layers has 128 units, with 30% dropout, and tanh activation function. The parameters θₗₛₜₘ of the LSTM based model was trained using same demonstration data T. The GM reward function (14), the NS reward function (15) and the LSTM reward function (16) were employed as examples (Experiments 10, 11, 12).

The forward model (FM) based reward estimation that is based on predicting the next state given both the current state and action was also evaluated as a comparative example (Experiment 13). The behavior cloning (BC) method was also evaluated as a comparative example (Experiment 14: baseline). The parameters α, β, and γ are 100, 1 and 10, respectively.

FIG. 6B shows difference in performance of the reinforcement learning of the various reward functions in the Reacher task to the random point target. In all cases using estimated rewards, the performance was significantly better than the result of the sparse reward (Experiment 9). The LSTM based reward function (Experiment 12) showed the best results, reaching close to the performance obtained by the dense hand engineered reward function (Experiment 8). The NS model estimated reward (Experiment 11) showed comparable performance with the LSTM based prediction model (Experiment 12) during the initial episodes. The FM based reward function (Experiment 13) performed poorly in this experiment. Comparatively, the direct BC (Experiment 14) worked relatively well.

Mover with Avoiding Obstacle

For the mover task, the temporal sequence prediction model was employed. A finite history of the state values was used as input to predict the next state value. It was assume that predicting a part of the state that is related to a given action allows the model to make a better estimate of the reward function. The function ψ was changed to a Gaussian function (as compared to the hyperbolic tangent (tanh) function used in Reacher tasks).

The environment shown in FIG. 2B where the point agent 222 can move in a 2-dimensional plane (x, y) according to the position control was built. The initial position of the point agent 222 was initialized randomly. The position of the point target 226 (p_{tgt}) and the position of the obstacle 224 (p_{obs}) were also set randomly. The state vector sₜ includes the agent's absolute position (pₜ), the current velocity of the point agent (dpₜ/dt), the target absolute position (p_{tgt}), the obstacle absolute position (p_{obs}), and the relative location of the target and the obstacle with respect to the point agent (pₜ−p_{tgt}, pₜ−p_{obs}). The RL algorithm was DDPG for continuous control. The number of steps for each episode was 500.

The reward functions used in the Mover task were as follows:

$$\begin{matrix} Dense reward \text{:} {r}_{t} = - {‖ {p}_{t} - {p}_{tgt} ‖}_{2} + {‖ {p}_{t} - {p}_{obs} ‖}_{2} , & ( 18 ) \\ LSTM reward \text{:} {r}_{t} = exp ( - {‖ {s}_{t + 1} - h ( {s}_{t - n : t} ; {θ}_{lstm} ) ‖}_{2} / 2 {σ}_{1}^{2} ) , & ( 19 ) \\ LSTM ( state \text{-} selected ) reward \text{:} {r}_{t} = exp ( - {‖ {s}_{t + 1}^{′} - {h}^{′} ( {s}_{t - n : t} ; {θ}_{lstm} ) ‖}_{2} / 2 {σ}_{2}^{2} ) , & ( 20 )\end{matrix}$$

where h′(s_{t-n:t}; θₗₛₜₘ) is a network that predicts a selected part of state values given a finite history of states. The agent's absolute position (pₜ) was used as the selected part of the state values in this experiment. The dense reward is composed of both, the cost for the target distance and the bonus for the obstacle distance. The expert state trajectories τ contains 800 “human guided” demonstrations. The dense reward function was employed as a comparative example (Experiment 15). The LSTM based model includes two layers, each with 256 units with ReLU activations, and a fully-connected final layer, as shown in FIG. 5A. The parameter σ₁ and σ₂ were set to 0.005 and 0.002, respectively. The LSTM reward function and LSTM (state selected) reward function were employed as examples (Experiments 16, 17).

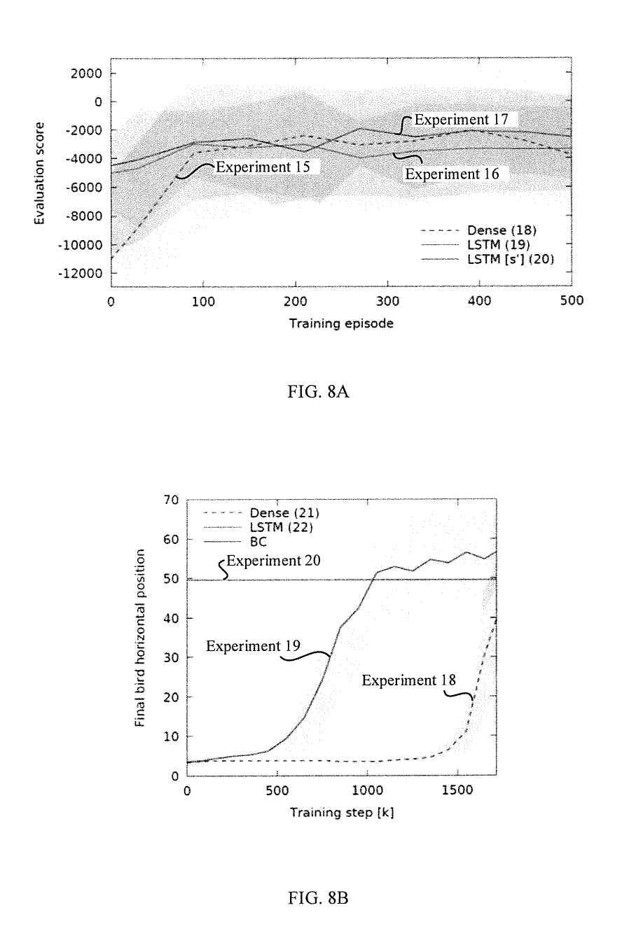

FIG. 8A shows performance of the different reward functions in the Mover task. As shown in FIG. 8A, the LSTM based model (Experiments 16, 17) learnt to reach the target faster than the dense reward (Experiment 15), while the LSTM (s′) (Experiment 17) showed the best over all performances.

Flappy Bird™

A re-implementation of Android™ game, “Flappy Bird™” in python (pygame) was used. The objective of the game is to pass through the maximum number of pipes without collision. The control is a single discrete command of whether to flap the bird wings or not. The state information has four consecutive gray frames (4×80×80). DQN was employed as the RL algorithm, and the update frequency of the deep network was 100 steps. The DQN has three convolutional (kernel size are 8×8, 4×4, and 3×3, the number of the filters are 32, 64, and 64, and the number of the stride are 4, 2, and 1), one fully connected layer (512), and final layer. The ReLU activation function is inserted after each layer. The Adam optimizer was used, and mean square loss was used. Replay memory size is 2M, batch size is 256, and other parameters are followed the repository.

The reward functions used in the task of the Flappy Bird™ were as follows:

$$\begin{matrix}Dense reward \text{:} {r}_{t} = \{ \begin{matrix}+ 0.1 & if alive ; \\ + 1 & if pass through a pipe ; \\ - 1 & if collide to a pipe ,\end{matrix} & ( 21 ) \\ LSTM reward \text{:} {r}_{t} = exp ( - {‖ {s}_{t + 1}^{′} - {h}^{′} ( {s}_{t} ; {θ}_{lstm} ) ‖}_{2} / 2 {σ}^{2} ) , & ( 22 )\end{matrix}$$

where s′ₜ₊₁ is an absolute position of the bird, which can be given from simulator or it could be processed by pattern matching or CNN from raw images and h′(sₜ;θₗₛₜₘ) is an absolute position predicted from raw images sₜ. The LSTM based model includes two convolutional LSTM layers (3×3), each with 256 units with ReLU activations, one LSTM layer with 32 unit and a fully-connected final layer. The LSTM based model was trained to predict the absolute position of the bird location given images. The expert demonstrations c was 10 episodes data from a trained agent in the repository. The LSTM reward function was employed as an example (Experiment 19). The parameter σ is 0.02. The behavior cloning (BC) method was also performed as a comparative example (Experiment 20) for baseline.

FIG. 8B shows difference in performance of the reinforcement learning of the reward functions in the task of the Flappy Bird™. The result of the LSTM reward (Experiment 19) was better than the normal “hand-crafted” reward (Experiment 18). The LSTM based model (Experiment 19) showed better convergence than the result of the BC method (Experiment 20).

Super Mario Bros.™

The Super Mario Bros.™ classic Nintendo™ video game environment was prepared. The reward values were estimated based on expert game play video data (i.e., using only the state information in the form of image frames). Unlike in the actual game, the game was always initialized so that Mario states the starting position rather than a previously saved checkpoint. A discrete control setup was employed, where Mario can make 14 types of actions. The state information includes a sequential input of four 42×42 gray image frames. Every next six frames were skipped. The A3C RL algorithm was used as the reinforcement learning algorithm. The objective of the agent is to travel as far as possible and achieve as high a score as possible in the game play stage “1-1”.

The reward functions used in the task of Super Mario Bros.™ were as follows:

$$\begin{matrix}Zero reward \text{:} {r}_{t} = 0 , & ( 23 ) \\ Distance reward \text{:} {r}_{t} = {position}_{t} - {position}_{t - 1} , & ( 24 ) \\ Score reward \text{:} {r}_{t} = {score}_{t} , & ( 25 ) \\ Curiosity \text{:} {r}_{t} = η {‖ φ ( {s}_{t + 1} ) - f ( φ ( {s}_{t + 1} ) , {a}_{t} ; {θ}_{F} ) ‖}_{2} , & ( 26 ) \\ 3 D - CNN ( naive ) reward \text{:} {r}_{t} = 1 - {‖ {s}_{t + 1} - h ( {s}_{t - n : t} ; θ ) ‖}_{2} , & ( 27 ) \\ 3 D - CNN reward \text{:} {r}_{t} = max ( 0 , ζ - {‖ {s}_{t + 1} - h ( {s}_{t - n : t} ; θ ) ‖}_{2} ) , & ( 28 )\end{matrix}$$

where positionₜ is the current position of Mario at time t, scoreₜ is the current score value at time t, and sₜ are screen images from the Mario game at time t. The position and score information were obtained using the game emulator.

A 3D-CNN shown in FIG. 5B was employed as the temporal sequence prediction model. In order to capture expert demonstration data, 15 game playing videos performed by five different people were prepared. All videos consisted of games where the player succeeded in clearing the stage. In total, the demonstration data consisted of 25000 frames. The length of skipped frames in input to the temporal sequence prediction model was 36, as humans cannot play as fast as an RL agent; however, the skip frame rate for the RL agent was not changed.

The 3D-CNN consists of four layers (two layers with (2×5×5), two layers with (2×3×3) kernels, all have 32 filters, and every two layers with (2, 1, 1) stride) and a final layer to reconstruct image. The agent was trained using 50 epochs with a batch size of 8. Two prediction models were implemented for reward estimation. In the naive method (27), the Mario agent will end up getting positive rewards if it sits in a fixed place without moving. This is because it can avoid dying by just not moving. However, clearly this is a trivial suboptimal policy. Hence, a modified reward function (28) is implemented based on the same temporal sequence prediction model by applying a threshold value that prevents the agent from converging onto such a trivial solution. The value of ζ in the modified reward function (28) is 0:025, which was calculated based on the reward value obtained by just staying fixed at the initial position.

The zero reward (23), the reward function based on the distance (24) and the reward function based on the score (25) were employed as comparative examples (Experiments 21, 22 and 23). The recently proposed curiosity-based method (Deepak Pathak, et. al, Curiosity-driven exploration by self-supervised prediction, In International Conference on Machine Learning (ICML), 2017) was also conducted as the baseline (Experiment 24). The 3D-CNN (naive) reward function (27) and the modified 3D-CNN reward function (28) were employed as examples (Experiments 25, Example 26).

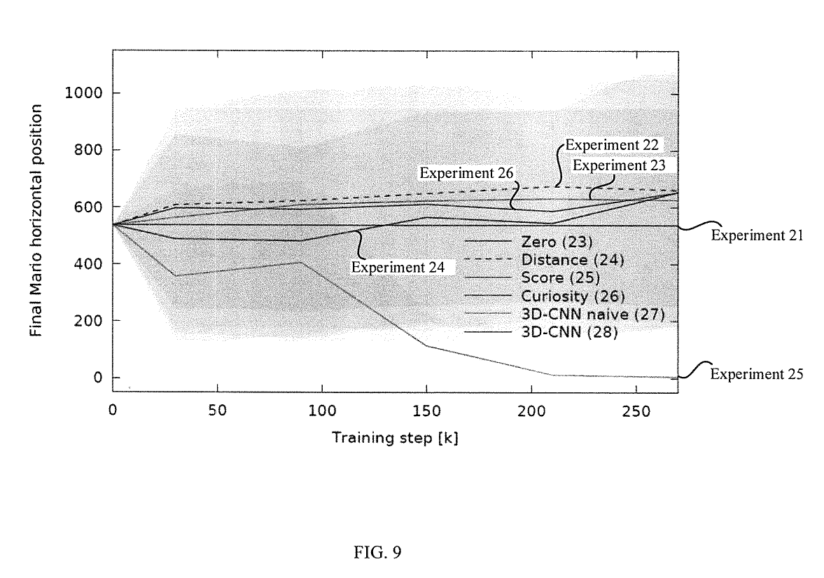

FIG. 9 shows performance of reinforcement learning for the task of the Super Mario Bros.™ with the various reward functions. In FIG. 9, the graphs directly show the average results over multiple trials. As observed, the agent was unable to reach large distances even while using “hand-crafted” dense rewards and did not converge to the goal every time. As observed from the average curves of FIG. 9, the 3D-CNN reward functions (Experiment 26) learned relatively faster as compared to the curiosity-based agent (Experiment 24).

Computer Hardware Component

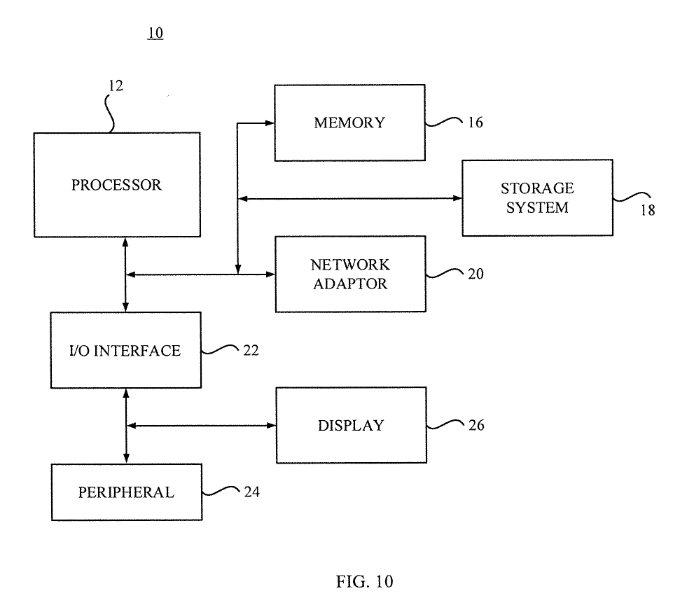

Referring now to FIG. 10, a schematic of an example of a computer system 10, which can be used for the reinforcement learning system 110, is shown. The computer system 10 shown in FIG. 10 is implemented as computer system. The computer system 10 is only one example of a suitable processing device and is not intended to suggest any limitation as to the scope of use or functionality of embodiments of the invention described herein. Regardless, the computer system 10 is capable of being implemented and/or performing any of the functionality set forth hereinabove.

The computer system 10 is operational with numerous other general purpose or special purpose computing system environments or configurations. Examples of well-known computing systems, environments, and/or configurations that may be suitable for use with the computer system 10 include, but are not limited to, personal computer systems, server computer systems, thin clients, thick clients, hand-held or laptop devices, in-vehicle devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 10 may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 10, the computer system 10 is shown in the form of a general-purpose computing device. The components of the computer system 10 may include, but are not limited to, a processor (or processing circuitry) 12 and a memory 16 coupled to the processor 12 by a bus including a memory bus or memory controller, and a processor or local bus using any of a variety of bus architectures.

The computer system 10 typically includes a variety of computer system readable media. Such media may be any available media that is accessible by the computer system 10, and it includes both volatile and non-volatile media, removable and non-removable media.

The memory 16 can include computer system readable media in the form of volatile memory, such as random access memory (RAM). The computer system 10 may further include other removable/non-removable, volatile/non-volatile computer system storage media. By way of example only, the storage system 18 can be provided for reading from and writing to a non-removable, non-volatile magnetic media. As will be further depicted and described below, the storage system 18 may include at least one program product having a set (e.g., at least one) of program modules that are configured to carry out the functions of embodiments of the invention.

Program/utility, having a set (at least one) of program modules, may be stored in the storage system 18 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

The computer system 10 may also communicate with one or more peripherals 24 such as a keyboard, a pointing device, a car navigation system, an audio system, etc.; a display 26; one or more devices that enable a user to interact with the computer system 10; and/or any devices (e.g., network card, modem, etc.) that enable the computer system 10 to communicate with one or more other computing devices. Such communication can occur via Input/Output (I/O) interfaces 22. Still yet, the computer system 10 can communicate with one or more networks such as a local area network (LAN), a general wide area network (WAN), and/or a public network (e.g., the Internet) via the network adapter 20. As depicted, the network adapter 20 communicates with the other components of the computer system 10 via bus. It should be understood that although not shown, other hardware and/or software components could be used in conjunction with the computer system 10. Examples, include, but are not limited to: microcode, device drivers, redundant processing units, external disk drive arrays, RAID systems, tape drives, and data archival storage systems, etc.

Computer Program Implementation

The present invention may be a computer system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more aspects of the present invention has been presented for purposes of illustration and description, but is not intended to be exhaustive or limited to the invention in the form disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for estimating a reward in reinforcement learning, the method comprising:
preparing a state prediction model trained to predict a state for an input using visited states in expert demonstrations performed by an expert;
inputting an actual state observed by an agent in reinforcement learning into the state prediction model to calculate a predicted state; and
estimating a reward in the reinforcement learning based, at least in part, on similarity between the predicted state and an actual state observed by the agent.

2. The computer-implemented method of claim 1, wherein the method further comprises:
training the state prediction model using the visited states in the expert demonstrations without actions executed by the expert in relation to the visited states.

3. The computer-implemented method of claim 1, wherein the state prediction model is a generative model, and both of the actual state defining the similarity and the actual state inputted into the generative model are observed at a same time step, the method further comprising:
training the generative model so as to minimize an error between a visited state in the expert demonstrations and a reconstructed state from the visited state.

4. The computer-implemented method of claim 3, wherein the generative model is an autoencoder that reconstructs a state as the predicted state from an actual state, the similarity being defined between the state reconstructed by the autoencoder and the actual state.

5. The computer-implemented method of claim 1, wherein the state prediction model is a temporal sequence prediction model, and the actual state inputted into the temporal sequence prediction model precedes the actual state defining the similarity, the method further comprising:
training the temporal sequence prediction model so as to minimize an error between a visited state in the expert demonstrations and an inferred state from one or more preceding visited states in the expert demonstrations.

6. The computer-implemented method of claim 5, wherein the temporal sequence prediction model is a next state model that infers a next state as the predicted state from an actual current state, the similarity being defined between the next state inferred by the next state model and an actual next state.

7. The computer-implemented method of claim 5, wherein the temporal sequence prediction model is a long short term memory (LSTM) based model that infers a next state as the predicted state from an actual state history or an actual current state, the similarity being defined between the next state inferred by the LSTM based model and an actual next state.

8. The computer-implemented method of claim 5, wherein the temporal sequence prediction model is a 3-dimensional convolutional neural network (3D-CNN) model that infers a next state as the predicted state from an actual state history or an actual current state, the similarity being defined between the next state inferred by the 3D-CNN based model and an actual next state.

9. The computer-implemented method of claim 1, wherein the expert demonstrations represents optimal behavior and the reward is estimated as a higher value as the similarity becomes high.

10. The computer-implemented method of claim 1, wherein the reward is based further on a cost for an action executed by the agent in the reinforcement learning in addition to the similarity.

11. The computer-implemented method of claim 1, wherein the reward is defined as a function of the similarity, the function is a hyperbolic tangent function, a Gaussian function or a sigmoid function.

12. The computer-implemented method of claim 1, wherein the method further comprises:
updating parameters in the reinforcement learning by using the reward estimated.

13. A computer system for estimating a reward in reinforcement learning, the computer system comprising:
a memory storing program instructions;
a processing circuitry in communications with the memory for executing the program instructions, wherein the processing circuitry is configured to:
prepare a state prediction model trained to predict a state for an input using visited states in expert demonstrations performed by an expert;
input an actual state observed by an agent in reinforcement learning into the state prediction model to calculate a predicted state; and
estimate a reward in the reinforcement learning based, at least in part, on similarity between the predicted state and an actual state observed by the agent.

14. The computer system of claim 13, wherein the processing circuitry is further configured to:
train the state prediction model using the visited states in the expert demonstrations without actions executed by the expert in relation to the visited states.

15. The computer system of claim 13, wherein the state prediction model is a generative model, and both of the actual state defining the similarity and the actual state inputted into the generative model are observed at a same time step, the processing circuitry being further configured to:
train the generative model so as to minimize an error between a visited state in the expert demonstrations and a reconstructed state from the visited state.

16. The computer system of claim 13, wherein the state prediction model is a temporal sequence prediction model, and the actual state inputted into the temporal sequence prediction model precedes the actual state defining the similarity, the processing circuitry being further configured to:
train the temporal sequence prediction model so as to minimize an error between a visited state in the expert demonstrations and an inferred state from one or more preceding visited states in the expert demonstrations.

17. A computer program product for estimating a reward in reinforcement learning, the computer program product comprising a computer readable storage medium having program instructions embodied therewith, the program instructions executable by a computer to cause the computer to perform a method comprising:
preparing a state prediction model trained to predict a state for an input using visited states in expert demonstrations performed by an expert;
inputting an actual state observed by an agent in reinforcement learning into the state prediction model to calculate a predicted state; and
estimating a reward in the reinforcement learning based, at least in part, on similarity between the predicted state and an actual state observed by the agent.

18. The computer program product of claim 17, wherein the method further comprises:
training the state prediction model using the visited states in the expert demonstrations without actions executed by the expert in relation to the visited states.

19. The computer program product of claim 17, wherein the state prediction model is a generative model, and both of the actual state defining the similarity and the actual state inputted into the generative model are observed at a same time step, the method further comprising:
training the generative model so as to minimize an error between a visited state in the expert demonstrations and a reconstructed state from the visited state.

20. The computer program product of claim 17, wherein the state prediction model is a temporal sequence prediction model, and the actual state inputted into the temporal sequence prediction model precedes the actual state defining the similarity, the method further comprising:
train the temporal sequence prediction model so as to minimize an error between a visited state in the expert demonstrations and an inferred state from one or more preceding visited states in the expert demonstrations.
